(19) United States
(12) Patent Application Publication
(10) Pub. No.: US 2017/0228440 A1
(43) Pub. Date: Aug. 10, 2017

(54) METHOD OF FACILITATING PATTERN RECOGNITION THROUGH ORGANIZING DATA BASED ON THEIR SEQUENCING RELATIONSHIP

(71) Applicant: Virdree BURNS, New York, NY (US)

(72) Inventor: Virdree BURNS, New York, NY (US)

(21) Appl. No.: 15/040,158

(22) Filed: Feb. 10, 2016

(51) Int. Cl. G06F 17/30

(52) U.S. Cl. CPC G06F 17/30551; G06F 17/30988; G06F 17/30525; G06F 17/30554

(57) ABSTRACT

A method for analyzing chronological datasets for anticipating at least one progression and/or null set thereof is provided. Once provided a historic dataset having a plurality of data units ordered chronologically, the method includes adding a predetermined value to each of the plurality of data units that has chronologically been most recently added to the plurality of data units, thereby creating a resulting number associated with said data unit; discarding the resulting number if greater than a future value of a chronologically next data unit of the plurality of data units; otherwise organizing the resulting number with the associated data unit, forming a first sequenced subset; repeating the above steps in respect of second and/or further chronologically most recently added data units of the plurality of data units, and forming a second sequenced subset using negative versions of the predetermined values.

### BACKGROUND OF THE INVENTION

The present invention relates to technical field of data analysis and, more particularly, to a method for organizing known data into groups based in part on their sequencing relationships, facilitating pattern recognition of the known data.

An entity may imagine things that are erroneous, but it can only understand things that are right, unswerving and unwavering. Other methods, devices or systems fail to define or organize a sequence of known data in order to easily facilitate anticipated data or otherwise recognize patterns embedded in the known data, particularly when the known data is chronologically arranged. These current methods use complex mathematics calculation and as a result may miss straight forward solutions through over-thinking a problem and thus loss of vision to a desired outcome.

As can be seen, there is a need for a method for organizing known data into groups based in part on their sequencing relationships, facilitating pattern recognition of the known data.

### SUMMARY OF THE INVENTION

In one aspect of the present invention, there is a resulting increase in a user's capability to choose structure conditions for a dataset's progression,

In another aspect of the present invention, is directed to apparatus to increase chance predictions of integers. To that end means are provided to predict future integer outcomes based on sequence weighted by historical datasets.

In yet another aspect of the present invention, a method for analyzing chronological datasets for anticipating at least one progression and/or null set thereof includes the steps of: (a) providing a historic dataset having a plurality of data units ordered chronologically; (b) adding a predetermined value to each of the plurality of data units that has chronologically been most recently added to the plurality of data units, thereby creating a resulting number associated with said data unit; (c) discarding the resulting number if greater than a future value of a chronologically next data unit of the plurality of data units; (d) otherwise organizing the resulting number with the associated data unit, forming a first sequenced subset; and (e) repeating steps (b) through (d) in respect of second and/or further chronologically most recently added data units of the plurality of data units.

These and other features, aspects and advantages of the present invention will become better understood with reference to the following drawings, description and claims.

### BRIEF DESCRIPTION OF THE DRAWINGS

FIG. 1 is a flowchart of an exemplary embodiment of the present invention;

FIG. 2 is a continuation of FIG. 1;

FIG. 3 is a continuation of FIG. 2;

FIG. 4 is a schematic view of an exemplary embodiment of an sequence spreadsheet of the present invention; and

FIG. 5 is a schematic view of an exemplary embodiment of an historic dataset of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for organizing known data into groups based in part on their sequencing relationships, facilitating pattern recognition of the known data.

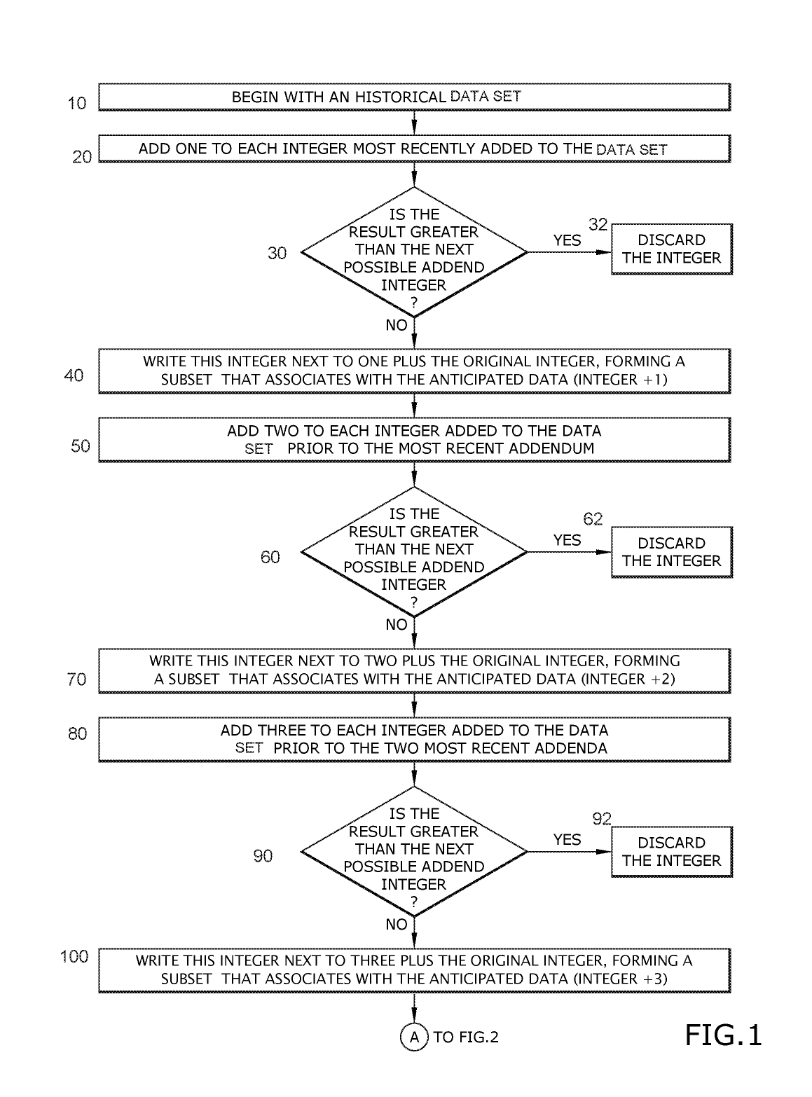

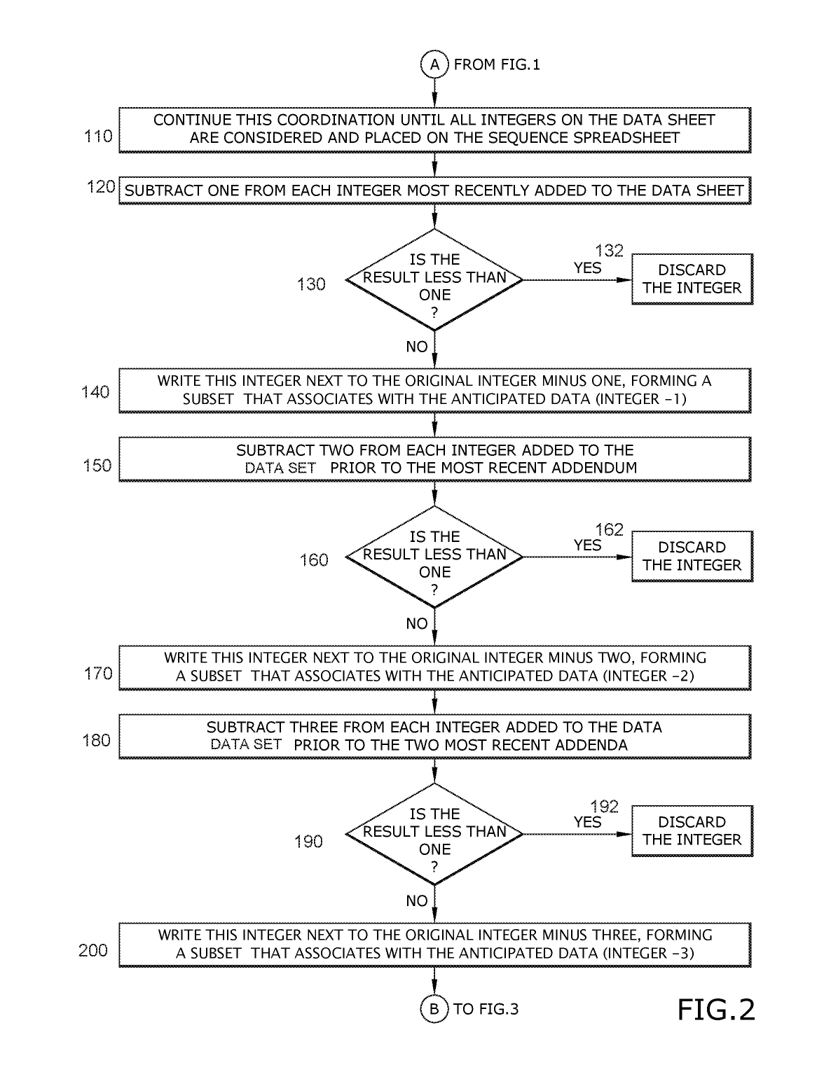

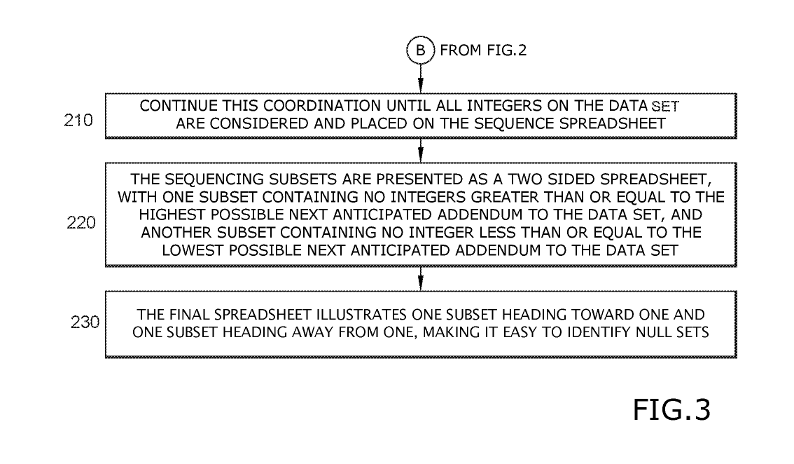

Referring to FIGS. 1 through 3, the present invention may include a sequencing method for a historical dataset 500. The historical dataset 500 may include a plurality of data units. The data units may be integers. The integers may be arranged chronologically, such as found in a state's published lottery data.

Generally the sequencing method, applies a plurality of addendum of predetermined values throughout the historical dataset 500 (plurality of original integers), obtaining resulting integers by adding and subtracting the predetermined values based on where the original integer is found in the historic dataset 500. Once this arithmetic is done, the method discards a resulting integer if it falls outside the spreadsheet parameters or inputs the resulting integer into a sequence spreadsheet 400, forming two opposing sequence subsets.

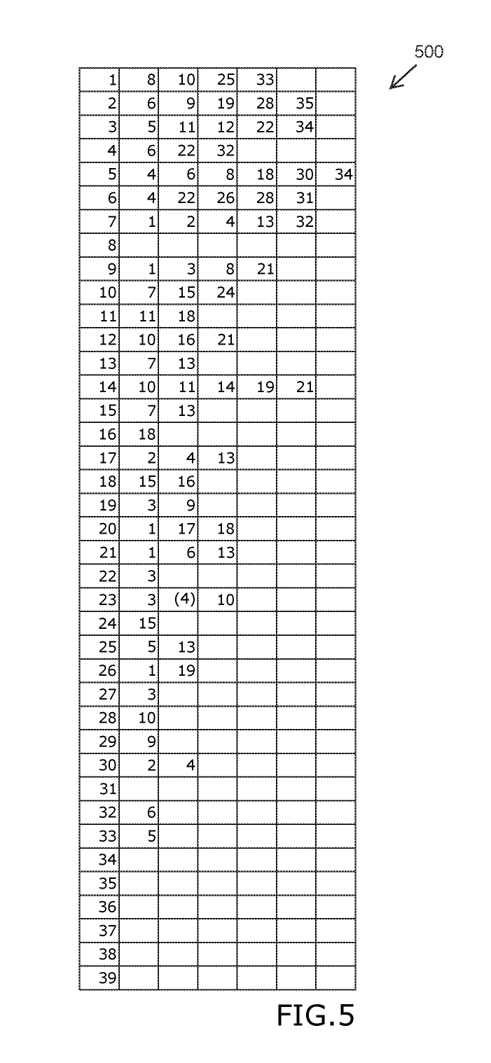

The sequencing method may include the step of providing the historical dataset 500, as illustrated in FIG. 5, in step 10. In step 20, the method may include adding ‘1’ to each original integer that is most recently addended to the historical dataset 500, forming a first resulting number. In step 30, the method determines if the first resulting number is greater than the possible next addend integer (an example of a sequence parameter) so that if true (“yes”) then the first resulting number is discarded (in step 32), but if false (“no”) then the first resulting number is aligned with the original integer, forming a first subset, in step 40. The first subset may associate a first anticipated data (integer +1) with each applicable original integer. Write the first anticipated data at original integer +1

In step 50, the method may include adding ‘2’ to each original integer immediately prior to the most recently added to the historical dataset 500, forming a second resulting number. In step 60, the method determines if the second resulting number is greater than the possible next addend integer (i.e., the sequence parameter) so that if true (“yes”) then the second resulting number is discarded (in step 62), but if false (“no”) then the second resulting number is aligned with the original integer, forming a second subset, in step 70. The second subset may associate a second anticipated data (integer +2) with each applicable original integer. Write the first anticipated data at original integer +2.

In step 80, the method may include adding ‘3’ to each original integer prior to the two most recently added to the historical dataset 500, forming a third resulting number. In step 90, the method determines if the third resulting number is greater than the possible next addend integer (sequence parameter) so that if true (“yes”) then the third resulting number is discarded (in step 92), but if false (“no”) then the third resulting number is aligned with the original integer, forming a third subset, in step 100. The third subset may associate a third anticipated data (integer +3) with each applicable original integer. Write the first anticipated data at original integer +3.

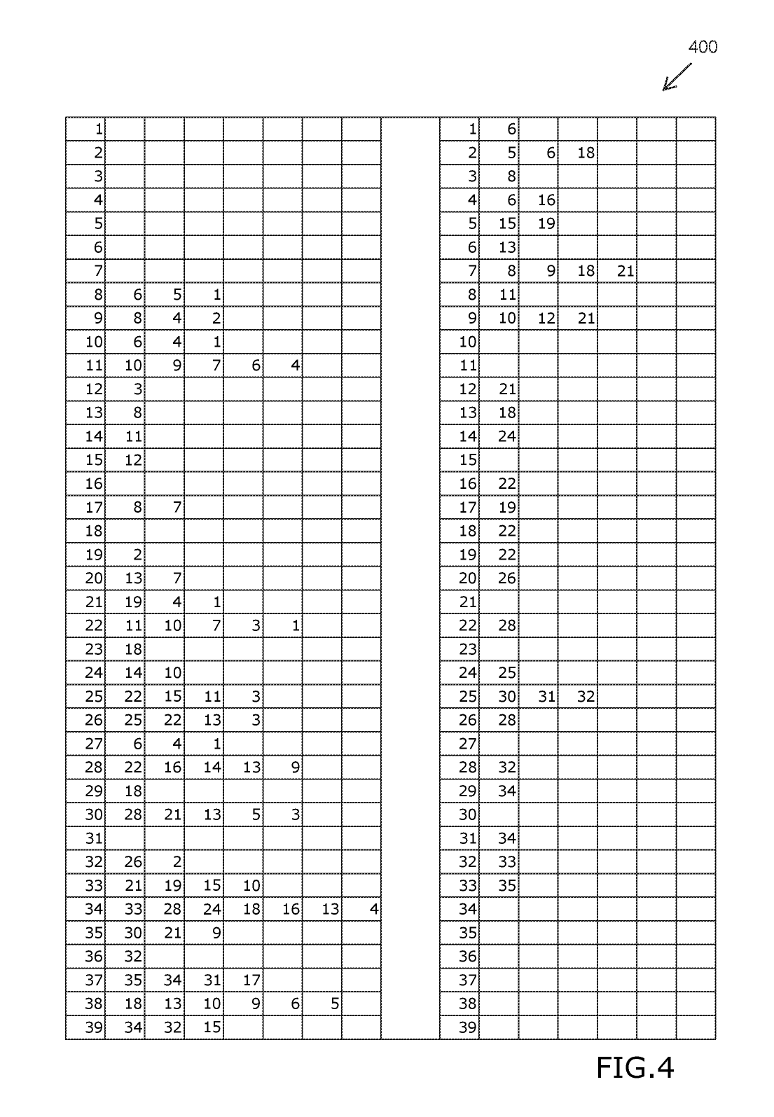

In step 110, the method may continue this algorithm through the historical dataset 500 so that all data units thereof are considered and sequenced accordingly on a first side of a sequence spreadsheet 400, as illustrated in FIG. 4.

In step 120, the method may include subtracting ‘1’ to each original integer most recently addended to the historical dataset 500, forming a first prime resulting number. In step 130, the method determines if the first prime resulting number is less than the possible next addend integer (sequence parameter) so that if true (“yes”) then the first prime resulting number is discarded (in step 132), but if false (“no”) then the first prime resulting number is aligned with the original integer, forming a first prime subset, in step 140. The first prime subset may associate a first prime anticipated data (integer −1) with each applicable original integer. Write the first anticipated data at original integer −1.

In step 150, the method may include subtracting ‘2’ to each original integer immediately prior to the most recently added to the historical dataset 500, forming a second prime resulting number. In step 160, the method determines if the second prime resulting number is less than the possible next addend integer (sequence parameter) so that if true (“yes”) then the second prime resulting number is discarded (in step 162), but if false (“no”) then the second prime resulting number is aligned with the original integer, forming a second prime subset, in step 170. The second prime subset may associate a second prime anticipated data (integer −2) with each applicable original integer. Write the first anticipated data at original integer −2.

In step 180, the method may include subtracting ‘3’ to each original integer prior to the two most recently added to the historical dataset 500, forming a third prime resulting number. In step 190, the method determines if the third prime resulting number is less than the possible next addend integer (sequence parameter) so that if true (“yes”) then the third prime resulting number is discarded (in step 192), but if false (“no”) then the third prime resulting number is aligned with the original integer, forming a third prime subset, in step 200. The third prime subset may associate a third prime anticipated data (integer −3) with each applicable original integer. Write the first anticipated data at original integer −3.

In step 210, the method may continue this algorithm through the historical dataset 500 so that all data units thereof are considered and sequenced accordingly on a second side of the sequence spreadsheet 400, so that is appears as a two-sided sequence spreadsheet 400, in step 220, as illustrated in FIG. 4. The resulting two-sided sequence spreadsheet 400 forms first sequencing subsets containing no elements or integers less than the highest possible next anticipated addendum to the historical dataset 500 on the first side, while the second side will form second sequencing subsets containing elements integers greater than 1. Numbering these formed first and second sequencing subsets consecutively illustrates the first sequencing subset heading toward 1 and the second side, second sequencing subset heading away from 1, in step 230.

A user of the sequencing method may be able to analyze the finite set of sequences that make up a given chronological historic dataset 500 so as to anticipate the progression of the historic dataset 500, facilitating the determination of null sets. By organizing the sequenced subsets according to the above disclosure, the user may develop a mentally digestible spreadsheet representation they can use to create strategies, since the resulting arrays of sequencing subsets are subordinated to a behavior pattern, for instance the behavior of lottery drawings.

In certain embodiments, the resulting arrays of sequencing subsets may be graphically representing—in a drawing for example—that better illustrates equality of the sequences subsets with all the set groups, and thus the underlying patterns (of behavior) and null sets would be more immediately discernible.

In alternative embodiments, the sequencing method can be used in the following processes: nursing home and day care health settings in order to stimulate activities of daily living; in education settings to test scholastic aptitude in diagram reading with queries such as ‘find the oldest null set’, ‘where will null set intersect’, ‘find the point where the sequences cross relative to first forming’ and to enable sequence studies in these educational settings; or resorts dedicated to process will couple hospitality to the analysis activity of the complete invention. The method of the present invention increases a user's capability to choose structure conditions for a dataset's progression. The present invention as a whole is directed to increasing chance predictions of integers. To that end means are provided to predict future integer outcomes based on sequence weighted by historical datasets.

Furthermore, the present invention may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like. Wherein the program product comprising machine-readable program code for causing, when executed, the computer to perform the =process steps disclosed and described above.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for analyzing chronological datasets for anticipating at least one progression and/or null set thereof, comprising the steps of:
(a) providing a historic dataset having a plurality of data units ordered chronologically;
(b) adding a predetermined value to each of the plurality of data units that has chronologically been most recently added to the plurality of data units, thereby creating a resulting number associated with said data unit;
(c) discarding the resulting number if greater than a future value of a chronologically next data unit of the plurality of data units;
(d) otherwise organizing the resulting number with the associated data unit, forming a first sequenced subset; and
(e) repeating steps (b) through (d) in respect of second and/or further chronologically most recently added data units of the plurality of data units.

2. The method of claim 1, wherein the each of the plurality of data units are integers.

3. The method of claim 1, wherein the predetermined value starts with positive one and sequentially increases with every step (e).

4. The method of claim 3, further providing at least one sequence parameter, and wherein the predetermined value through step (e) is limited by the sequence parameter.

5. The method of claim 4, wherein after the at least one sequence parameter has been reached by the predetermined value through step (e), the predetermined value restarts with a negative one and sequentially decreases with every step (e), forming a second sequenced subset.

6. The method of claim 5, organizing the first and the second sequenced subsets side by sides on one display.
